(19) United States
(12) Patent Application Publication
(10) Pub. No.: US 2011/0304549 A1
(43) Pub. Date: Dec. 15, 2011

(54) MULTI-COLOR TRACK BALL FOR USE IN GAMING APPLICATIONS

(75) Inventors: Patrick Suverien, Brasschaat (BE); Kevin Schechtel, Algonquin, IL (US); James Perales, Algonquin, IL (US)

(73) Assignee: Suzo-Happ Group, Mt. Prospect, IL (US)

(21) Appl. No.: 12/815,836

(22) Filed: Jun. 15, 2010

(51) Int. Cl. G06F 3/033

(52) U.S. Cl. 345/167

(57) ABSTRACT

An opto-mechanical trackball assembly is disclosed with increased functionality. In accordance with an important feature of the invention, a plurality of polychromatic light sources, such as polychromatic LEDs (also known as RGB LEDs), are spaced apart and disposed adjacent the trackball. Such polychromatic LEDs can provide up to 256 colors as well as allow the intensity of the light emitted from the trackball to be controlled. In addition, sequencing the turning on and off of spaced apart polychromatic light sources can be used to simulate movement of the trackball to raise the level of interest in the game, for example, during periods when the game is not being played. The polychromatic LEDs can also be used to create a light show of different colors to draw interest to the game during periods of inactivity. In one embodiment of the invention, the polychromatic light sources are configured for use in arcade/casino games that accommodate multiple users. In such multiple player games, each player can select a color. The selected color is displayed during that player's turn. Thus, the trackball in accordance with the present invention provides increased functionality relative to known trackballs with monochromatic light sources.

### BACKGROUND OF THE INVENTION

1. Field of the Invention

The present invention relates to a multi-color trackball assembly for use in gaming applications and more particularly to a multi-color trackball assembly with increased functionality that allows player tracking in gaming applications and enables simulation of automatic movement of a trackball.

2. Description of the Prior Art

Trackballs are pointing devices used in computer and gaming applications. Trackballs essentially consist of a sphere mounted in housing. Movement of the sphere is detected and converted to X-Y movements of a cursor on an electronic display. Users are able to rotate the trackball in any direction to control movement of a cursor on an electronic display of a computer or gaming machine.

Both mechanical and optical trackballs are known. Optical trackballs include a trackball, light sources and photo detectors. The light sources and the photo detectors are configured to detect movement of the trackball in mutually perpendicular directions, such as, an X-direction and a Y-direction. Such optical trackballs are formed with reflective and non-reflective surfaces. Movement of the trackball devices is determined by detecting reflections of light from the various reflective surfaces on the trackball by way of the photo detectors. An example of an optical trackball is described in detail in US Patent Application Publication No. US 2003/0020690 A1, hereby incorporated by reference.

Opto-mechanical trackballs are also known. Examples of opto-mechanical trackballs are disclosed in U.S. Pat. No. 5,541,621 and US Patent Application Publications Nos. US 2005/0141224 A1 and US 2008/0316175 A1, hereby incorporated by reference. Such opto-mechanical trackballs include a trackball mounted to be in contact with a plurality of rollers. The rollers are configured within the trackball housing in a common plane so that movement of the trackball in any direction will cause at least one roller to rotate. Optical sensors sense the rotational movement of each roller. The signals from the optical sensors are translated to cursor signals which cause a cursor on an electronic display of a computer or gaming machine to move by an amount corresponding to the movement of the trackball. A detailed description of a trackball is provided in U.S. Pat. No. 5,541,621, hereby incorporated by reference.

Both illuminated and non-illuminated trackballs are known. Both types of trackballs operate in essentially the same manner. The only significant difference is that illuminated trackballs are formed from a light transmitting material. For example, white trackballs are known to be formed from an opaque material and are backlit by a light source, such as an incandescent light source. Colored trackballs are also known. Such colored trackballs are formed from light transmitting material, such as a semi-translucent material, and molded in a color of choice. Colored trackballs are also known in which the trackballs are formed from a light transmitting material and backlit by a plurality of selectable light sources, such as incandescent bulbs or light emitting diodes (LEDs).

U.S. Pat. No. 5,541,621 and US Patent Application Publication No. US 2008/0316175 A1 illustrate non-illuminated trackballs. Examples of said colored trackballs are disclosed in US Patent Application Publication No. US 2005/0141224 A1; Japanese Published Application No. 06-296216 and 01-089243. Both of the Japanese Published Applications illustrate a trackball formed from a light transmitting material that is backlit by a plurality of colored incandescent bulbs. The '224 application discloses the use of separate red, green and blue LEDs to backlight the trackball.

There are several problems with the multi-colored trackballs described above. For example, one problem with known illuminated trackballs relates to the limited functionality of such trackballs. More particularly, in such illuminated trackballs, the light sources are located adjacent one another to cause the trackball to emit a particular color. As such, the functionality of such trackballs is static and limited being on or off. Thus, there is a need for an illuminated trackball with increased functionality.

### SUMMARY OF THE INVENTION

Briefly, the present invention relates to a opto-mechanical trackball assembly with increased functionality. In accordance with an important feature of the invention, a plurality of polychromatic light sources, such as polychromatic LEDs (also known as RGB LEDs), are spaced apart and disposed adjacent the trackball. Such polychromatic LEDs can provide up to 256 colors as well as allow the intensity of the light emitted from the trackball to be controlled. In addition, sequencing the turning on and off of spaced apart polychromatic light sources can be used to simulate movement of the trackball to raise the level of interest in the game, for example, during periods when the game is not being played. The polychromatic LEDs can also be used to create a light show of different colors to draw interest to the game during periods of inactivity.

In one embodiment of the invention, the polychromatic light sources are configured for use in arcade/casino games that accommodate multiple users. In such multiple player games, each player can select a color. The selected color is displayed during that player's turn. Thus, the trackball in accordance with the present invention provides increased functionality relative to known trackballs with monochromatic light sources.

### DESCRIPTION OF THE DRAWING

These and other advantages of the present invention will be readily understood with reference to the following specification and attached drawing wherein:

FIG. 1 is perspective of a trackball assembly in accordance with the present invention.

FIG. 2 is a simplified elevational view illustrating the relationship between the ball, the rollers and the LEDs.

FIG. 3 is a graphical representation of the simulation of the movement of the ball in which the dotted circle is used to represent a fixed point on the trackball.

FIG. 4 is a perspective view of an arcade game illustrating the trackball assembly in accordance with the present invention integrated into an arcade game.

FIG. 5 is a block diagram of a control circuit for controlling the LEDs, illustrated in FIGS. 1-3.

FIG. 6 is an exploded perspective of the trackball assembly in accordance with the present invention.

FIG. 7 is a top isometric of the lower trackball assembly housing illustrating the an exemplary LED board in accordance with the present invention.

### DETAILED DESCRIPTION

The present invention relates to a opto-mechanical trackball assembly with increased functionality. The trackball assembly includes a trackball in contact with a plurality of rollers and sensors for detecting movement of the ball and converting such detected movement to x-y movement of a cursor on a display that forms a part of a computer system or an arcade or casino game. In accordance with an important feature of the invention, a plurality of polychromatic light sources, such as polychromatic LEDs (also known as RGB LEDs), are spaced apart and disposed adjacent the trackball. Such polychromatic LEDs can provide up to 256 colors as well as allow the intensity of the light emitted from the trackball to be controlled. In addition, sequencing the turning on and off of spaced apart light sources can be used to simulate movement of the trackball to raise the level of interest in the game, for example, during periods when the game is not being played. The polychromatic LEDs can also be used to create a light show of different colors to draw interest to the game during periods of inactivity. In one embodiment of the invention, the polychromatic light sources are configured for use in arcade/casino games that accommodate multiple users. In such multiple player games, each player can select a color. The selected color is displayed during that player's turn. Thus, the trackball in accordance with the present invention provides increased functionality relative to known trackballs with monochromatic light sources.

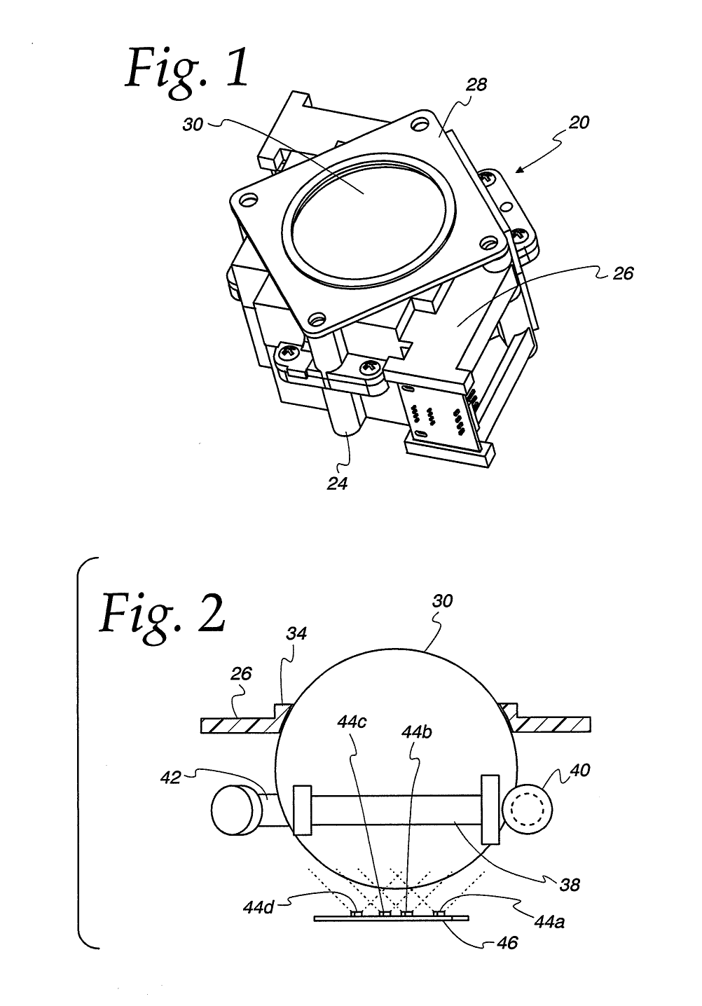

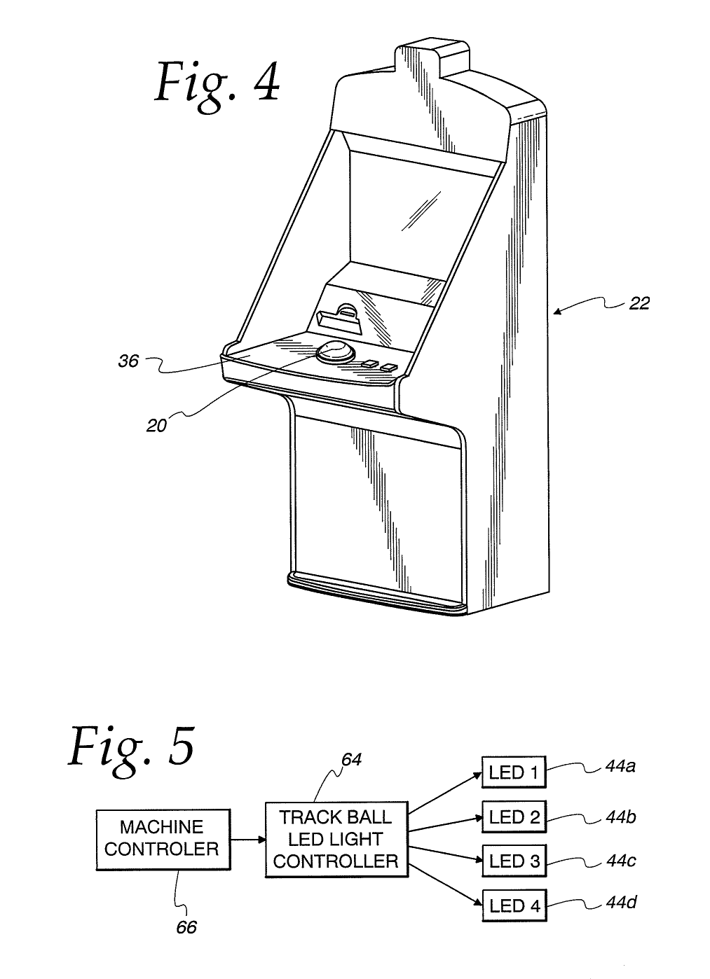

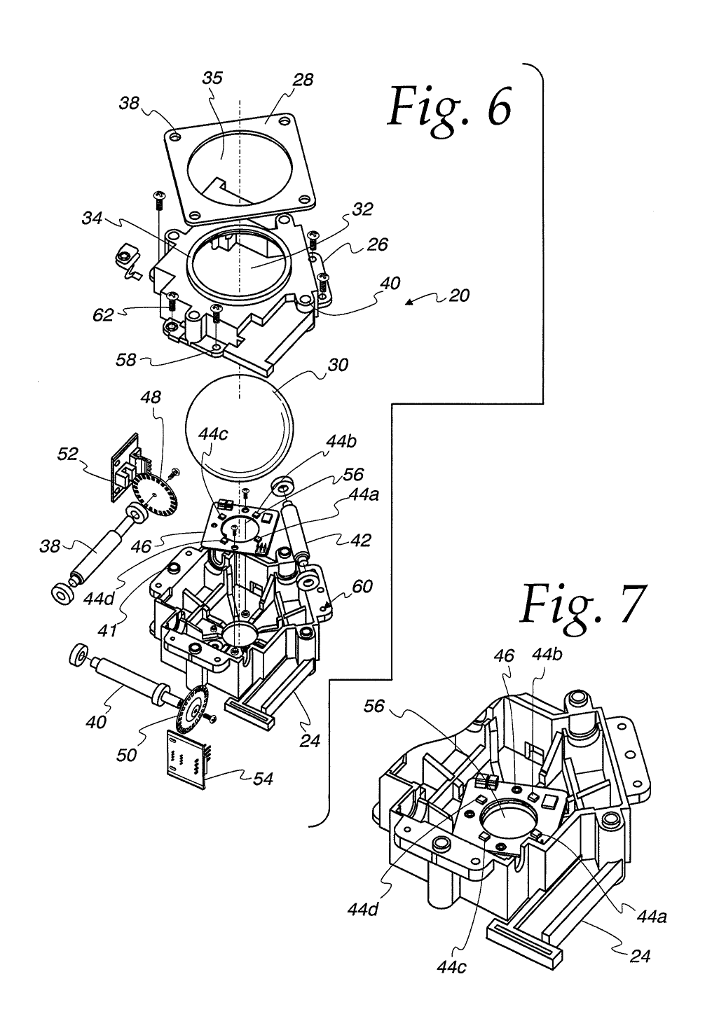

The trackball assembly in accordance with the present invention is illustrated in FIGS. 1 and 6 and generally identified with the reference numeral 20. The trackball assembly 20 is configured to be mounted to a conventional casino or arcade gaming machine 22, as generally illustrated in FIG. 4.

Referring first to FIG. 1, the trackball assembly 20 includes a lower housing 24, an upper housing 26, a trackball mounting bracket 28 and a trackball 30. The trackball 30 may be made from a transparent, semi-transparent or opaque material that enables light from a light source disposed adjacent the trackball 30 is able to illuminate the trackball 30. The trackball may also be made from translucent, semi opaque material, for example, [Kevin, please fill in an exemplary material that is translucent, semi opaque] The lower and upper housing 24 and 26, respectively, may be formed from a molded plastic material.

In order to mount the trackball assembly 20 to a arcade or gaming machine 22 (FIG. 4), the upper housing 26 (FIG. 6) is formed with a central aperture 32 and an integrally formed axially extending ring 34 (FIG. 4). A hole (not shown) slightly larger than the outer diameter of the ring 34 is cut in the desired mounting location on a panel 36 on the arcade or gaming machine 22. A subassembly which includes the lower housing 24 (FIG. 6), the upper housing 26 and the trackball 30 is disposed underneath the panel 36 (FIG. 4) and juxtaposed so that the ring 34 (FIG. 6) is received in the hole in the panel 36 (FIG. 4). The mounting bracket 28 (FIG. 6) is formed with a central aperture 35 for receiving the ring 34 is mounted on top of the panel 36 (FIG. 4). Additional apertures (not shown) are drilled the panel 36 for receiving fasteners (not shown). These additional apertures are located in the panel 36 (FIG. 4) so as to be aligned with apertures 38 and 40 in the mounting bracket 28 and upper housing 26 (FIG. 6), respectively, as well as apertures 41 formed in the lower housing 24. Fasteners (not shown) are received in the apertures 38 in the mounting bracket 28 which pass through the apertures in the panel 36 (FIG. 4) and are received in the apertures 40 (FIG. 6) in the upper housing 26 and the apertures 41 in the lower housing 24 to secure the track ball assembly 20 together and to the panel 36 (FIG. 4).

FIG. 2 is a simplified elevational view illustrating the relationship between the ball, the rollers and the light source. A portion of the upper housing 26 and the ring 34 is shown. When assembled, an arcuate portion of the trackball 30 extends upwardly above the upper housing 26 and the ring 34. Two (2) sensing rollers 38 and 40 and an idler roller form a cradle for the trackball 30. The sensing rollers 38 and 40 are generally disposed 90° apart. As will be discussed in more detail below, an optical sensing system, consisting of an encoder wheel, a light source, such as a light emitting diode (LED) and a phototransistor, is associated with each of the sensing rollers 38 and 40. The optical sensing system detects movement of the trackball in orthogonal planes and converts those movements to cursor signals in a known manner. The idler roller 42 simply forms the third leg of the cradle for the trackball 30.

In accordance with an important aspect of the invention, a plurality of spaced apart light sources are disposed adjacent the trackball 30 to provide enhanced functionality relative to known trackballs. As best shown in FIGS. 2 and 7, an exemplary embodiment of the invention is illustrated. More particularly, a plurality of light sources, identified with the reference numeral 44 are illustrated. Four (4) exemplary light sources are shown and identified with the reference numerals 44a, 44b, 44c and 44d. The light sources 44a, 44b, 44c and 44d, may be polychromatic LEDs, i.e. RGB LEDs. Such LEDs are four (4) pin devices including pins for the three (3) primary colors; red, green and blue; and an anode pin. Each polychromatic LED enables 256 different colors. A suitable polychromatic LED is a Model No. ______, manufactured by ______.

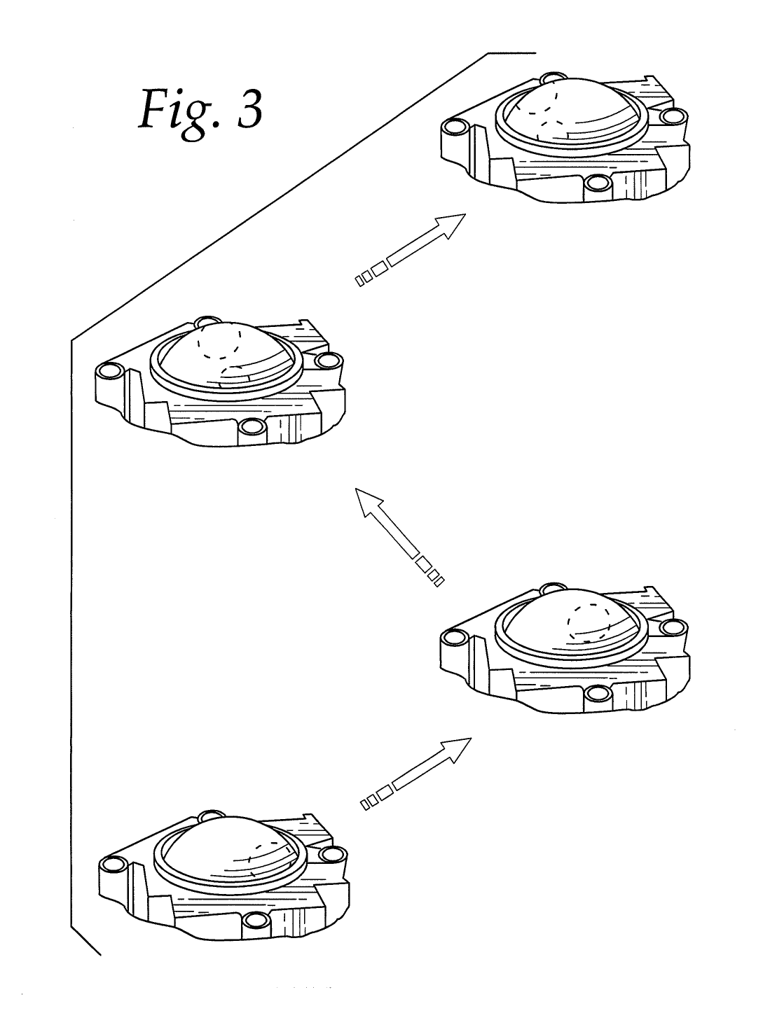

By utilizing polychromatic LEDs, a multitude of additional functionality can be provided to the trackball 30. For example, the LEDs 44a, 44b, 44c and 44d can be turned on and off at different times to simulate unattended movement of the trackball 30, as illustrated in FIG. 3. In addition to being able to provide 256 different colors, such polychromatic LEDs 44a, 44b, 44c and 44d can also be used to control the intensity of the light emitted from the trackball 30 by illuminating less than all of the LEDs 44a, 44b, 44c and 44d. As such, the trackball assembly in accordance with the present invention provides significant more functionality that conventional lighted trackballs with white and colored monochromatic light sources.

Referring to FIGS. 2 and 7, the polychromatic light sources 44a, 44b, 44c and 44d may be mounted on o printed circuit board (PCB) 46. In the exemplary embodiment shown, the PCB 46 enables all four (4) of the polychromatic light sources 44a, 44b, 44c and 44d to be spaced apart relative to the diameter of the trackball 30 and located on the same plane beneath the trackball 30. Other configurations of the polychromatic light sources 44a, 44b, 44c and 44d are contemplated such as non-planar an unequal or equal spacing between the polychromatic light sources 44a, 44b, 44c and 44d.

Spacing out the polychromatic light sources 44a, 44b, 44c and 44d relative to the diameter of the trackball 30 allows the emulation of the spinning of the trackball 30 by sequencing the turn on and turn off of the polychromatic light sources 44a, 44b, 44c and 44d. For example, initially turning on the polychromatic light source 44a and turning it off before turning on the polychromatic light source 44b. Similarly, the polychromatic light source 44b is turned off before turning on the polychromatic light source 44c. Finally, the polychromatic light source 44c is turned off before turning on the polychromatic light source 44d. The sequence may be repeated to create the appearance that the trackball 30 is spinning. Moreover, the sequence may be repeated in the same color or a different color.

An exploded perspective of the trackball assembly 20 in accordance with the present invention is illustrated in FIG. 6. As mentioned above, the trackball assembly 20 includes a trackball 30, a pair of sensing rollers 38 and 40 and an idler roller 42 which form a cradle for the trackball 30. Each of the sensing rollers 38 and 40 includes an optical encoding wheel 48 and 50, respectively. These encoding wheels 48 and 50 are rigidly mounted to the sensing rollers 38 and 40, respectively, so as to rotate when the sensing roller 38, 40 rotates. The encoding wheels 48, 50 cooperate with phototransistors (not shown) located on PCB boards 52 and 54, respectively, to generate electrical signals representative of rotation of the sensing rollers 38, 40. The encoding wheels 48, 50 phototransistors and the manner in which rotation of the encoding wheels 48, 50 is converted to electrical signals is well within the ordinary skill in the art.

The sensing rollers 38, 40 and the idler roller 42 are carried by the lower housing 24. In addition, the PCB 46 upon which the polychromatic light sources 44a, 44b, 44c and 44d are mounted is also carried by the lower housing. The PCB 46 may be provided with a central aperture 56 for receiving a portion of the trackball 30 on a non-contact basis. As mentioned above, the trackball 30 is carried by the cradle formed by the sensing rollers 38, 40 and the idler roller 42.

The upper housing 26 includes the central aperture for receiving a portion of the trackball 30 on an a non-contact basis. The upper housing 26 includes apertures, generally identified with the reference numeral 58 that are aligned with apertures 60 formed in the lower housing 24 that enable the lower 24 and upper 26 housings to be secured together, thus capturing the trackball 30 forming a subassembly. Mounting of the subassembly to a panel 36 (FIG. 4) by way of the mounting bracket 28 is discussed above.

An exemplary block diagram for the trackball assembly 30 is illustrated in FIG. 5. As mentioned above, the polychromatic light sources 44a, 44b, 44c and 44d or LEDs are four (4) pin devices. Each of the pins on the LEDs 44a, 44b, 44c and 44d are coupled to an output port (not shown) on a Track Ball LED Light Controller 64, implemented, for example, as a microcontroller. The Track Ball LED Light Controller 64 may be configured to be under the control of a Machine Controller 66, either partially or completely. For example, during periods of inactivity of the gaming machine 22 (FIG. 4), the Track Ball LED Light Controller 64 (FIG. 5) may receive a signal from the Machine Controller 66 indicating the inactivity of the gaming machine 22 (FIG. 4). Upon receipt of that signal, the Track Ball LED Light Controller 64 may, under its own program control, control the LEDs 44a, 44b, 44c and 44d to simulate rotation of the trackball 30 as discussed above or perform some other function, such as flashing the LEDs, sequencing the LEDs, varying the intensity of the LEDs or other light function. For multi-player games, the Track Ball LED Light Controller 64 is primarily under the control of the Machine Controller 66. In such an application, the Machine Controller 66 may prompt each player to select a color. After the color is selected, Machine Controller 66 commands the Track Ball LED Light Controller 64 to display that color. In other applications, in either a multi-player or single player game, the Machine Controller 66 commands the Track Ball LED Light Controller 64 to change colors or intensities of the LEDs based upon different operating modes of the game.

The multi-color LEDs 44a, 44b, 44c and 44d can be controlled to change colors during game play to indicate which player or team is up to play. In such games are selected at the beginning of the game. In such an application, the trackball controller 64 (FIG. 5) is under the control of the machine controller 66. More particularly, at the beginning of such games, the machine controller 66 would prompt a player to select a color. Once a color is selected, the machine controller 66 would prompt a subsequent player to select a color. Once all of the players have selected a color, the game is started with the trackball 30 (FIG. 6) being illuminated with the first player's selected color under the control of the machine controller 66 (FIG. 5). Once the first player's turn is completed, the machine controller 66 commands the trackball controller 64 to change the color of the trackball 30 (FIG. 6) to the next player's selected color. This process is repeated for all of the players or teams in a particular game.

Obviously, many modifications and variations of the present invention are possible in light of the above teachings. For example, the principles of the present invention can be incorporated into pushbuttons and joy sticks and other game controllers. Thus, it is to be understood that, within the scope of the appended claims, the invention may be practiced otherwise than as specifically described above.

What is claimed and desired to be secured by a Letters Patent of the United States is:

1. A trackball assembly with increased functionality, the trackball assembly comprising:
a trackball;
a pair of sensor rollers;
an idler roller, said sensor rollers and idler roller used to detect movement of said trackball;
one or more polychromatic light sources disposed adjacent said track ball for providing a number of light function; and
a housing for housing said trackball, said sensor rollers, said idler roller and said plurality of polychromatic light sources.
